(19) United States
(12) Patent Application Publication
(10) Pub. No.: US 2001/0025631 A1
(43) Pub. Date: Oct. 4, 2001

(54) Method and apparatus for preheating fuel in vehicles powered by internal combustion engines

(76) Inventors: William Jan Beekman, Sherwood Park (CA); Hermann E. Ergezinger, Edmonton (CA)

Correspondence Address: DAVIS & BUJOLD, P.L.L.C., 500 NORTH COMMERCIAL STREET, FOURTH FLOOR, MANCHESTER, NH, 03101, US

(21) Appl. No.: 09/776,293

(22) Filed: Feb. 2, 2001

(30) Foreign Application Priority Data
Mar. 31, 2000 (CA) 2,304,276

(51) Int. Cl. F02M 31/00

(52) U.S. Cl. 123/557

(57) ABSTRACT

A method and apparatus for preheating fuel in vehicles powered by internal combustion engines supplied with fuel from a fuel tank. A heat exchanger is provided for indirect heating of fuel. The heat exchanger has a fuel circulation conduit with a fuel inlet and a fuel outlet. The fuel inlet is connected to a first fuel flow line originating from the fuel tank. The fuel outlet is connected to a second fuel flow line extending to the internal combustion engine. A temperature sensor is positioned in the second fuel flow line. A control unit is coupled to the temperature sensor for controlling the temperature of the heat exchanger to maintain fuel within a predetermined temperature range as sensed by the temperature sensor.

### FIELD OF THE INVENTION

The present invention relates to a method and apparatus for preheating fuel in vehicles powered by internal combustion engines.

### BACKGROUND OF THE INVENTION

Internal combustion engines do not operate as efficiently under cold ambient fuel temperatures. Some success has been obtained in improving engine operation, improving fuel economy and reducing exhaust emissions by preheating the fuel. There has not been a widespread introduction of fuel preheaters, due to inconsistent results that are obtained through various apparatus that are available.

### SUMMARY OF THE INVENTION

What is required is a method and apparatus for preheating fuel in vehicles powered by internal combustion engines that will provide more consistent results.

According to one aspect of the present invention there is provided an apparatus for preheating fuel in vehicles powered by internal combustion engines. This is a combination apparatus that includes a vehicle powered by an internal combustion engine supplied with fuel from a fuel tank. A heat exchanger is provided for indirect heating of fuel. The heat exchanger has a fuel circulation conduit with a fuel inlet and a fuel outlet The fuel inlet is connected to a first fuel flow line originating from the fuel tank. The fuel outlet is connected to a second fuel flow line extending to the internal combustion engine. A temperature sensor is positioned in the second fuel flow line to the engine. A control unit is coupled to the temperature sensor for controlling the temperature of the heat exchanger to maintain fuel within a predetermined temperature range as sensed by the temperature sensor.

According to another aspect of the present invention there is provided a method for preheating fuel in vehicles powered by internal combustion engines involving the following steps. A first step involves installing a heat exchanger in a vehicle powered by an internal combustion engine, as described above. A second step involves placing a temperature sensor in the second fuel flow line and monitoring a temperature of fuel passing through the second fuel flow line, as described above. A third step involves making adjustments to maintain fuel passing along the second fuel flow line within a predetermined temperature range.

Research conducted by the Applicant into fuel performance indicated that heating the fuel had negligible effect on performance unless the fuel was heated to minimum threshold levels. However, if the fuel was heated above maximum levels the fuel began to vaporize. The vaporization of the fuel tended to cause: the engine to lose power, an increase in harmful emissions, and a decrease in fuel economy. With gasoline, the predetermined temperature range to which the fuel is heated should be not less than 40 degrees celsius and not more than 58 degrees celsius. With diesel, the predetermined temperature range to which the fuel is heated should be not less than 45 degrees celsius and not more than 74 degrees celsius.

Although beneficial results may be obtained through the use of the apparatus, as described above, a number of fluids, such as coolant, oil, and exhaust gas, are heated when an internal combustion engine operates. These heated fluids provide an inexpensive ready source of make up heat for the heat exchanger. Even more beneficial results may, therefore, be obtained when the heat exchanger has a heated fluid inlet and a heated fluid outlet This enables the heat exchanger to be heated by the circulation of heated fluid through the heated fluid inlet to the heated fluid outlet. A controller operates a valve to control flow of heated fluid through the heat exchanger.

### BRIEF DESCRIPTION OF THE DRAWINGS

These and other features of the invention will become more apparent from the following description in which reference is made to the appended drawings, wherein:

FIG. 1 is a schematic diagram of an apparatus for preheating fuel in vehicles powered by internal combustion engines constructed in accordance with the teachings of the present invention.

FIG. 2 is a side elevation view, in section, of a heat exchanger from the apparatus illustrated in FIG. 1.

### DETAILED DESCRIPTION OF THE PREFERRED EMBODIMENT

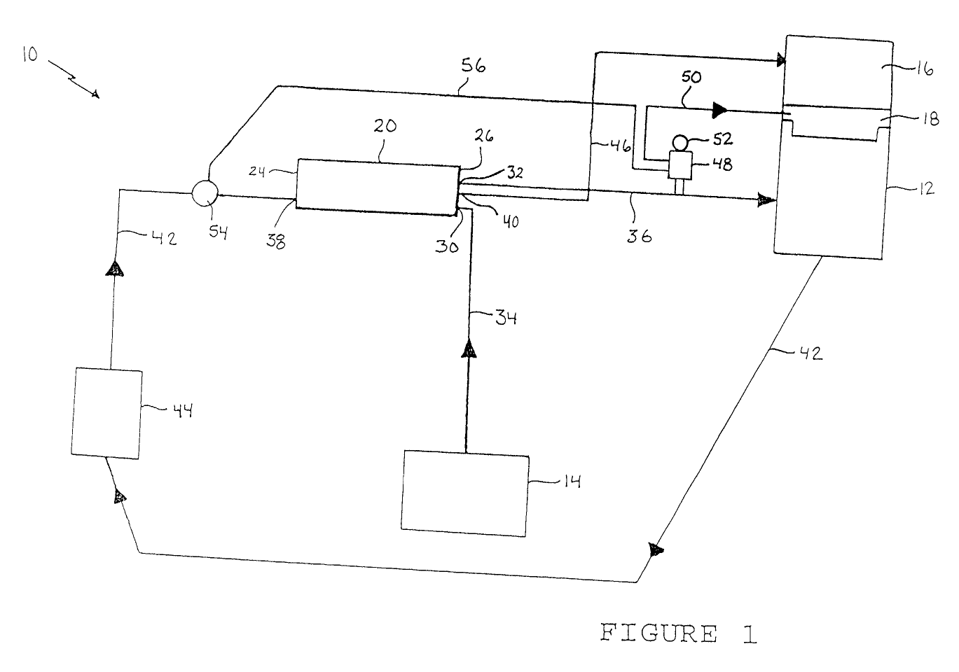

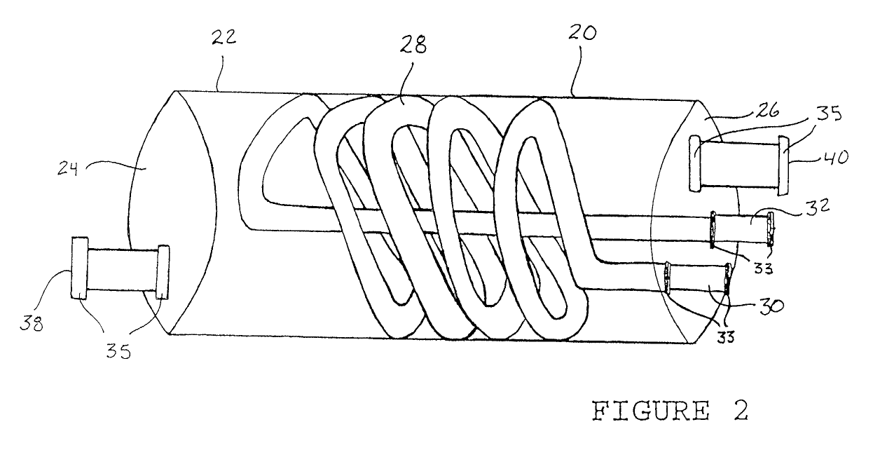

The preferred embodiment, an apparatus for preheating fuel in vehicles powered by internal combustion engines generally identified by reference numeral 10, will now be described with reference to FIGS. 1 and 2.

Referring to FIG. 1, there is provided an apparatus 10 for preheating fuel in vehicles powered by internal combustion engines. Apparatus 10 is comprised in combination of a vehicle powered by an internal combustion engine 12 supplied with gasoline fuel from a gasoline fuel tank 14. Internal combustion engine 12 has a radiator 16 and an engine manifold vacuum 18. Vehicle has a heat exchanger 20 for indirect heating of fluid.

Referring to FIG. 2, heat exchanger 20 has a cylindrical body 22 which has a first end 24 and a second end 26. Heat exchanger 20 has a fuel circulation conduit 28 contained within cylindrical body 22. Cylindrical body 22 of heat exchanger 20 has a fuel inlet 30 and a fuel outlet 32. In the illustrated embodiment, both fuel inlet 30 and fuel outlet 32 are located at second end 26 of cylindrical body 22 of heat exchanger 20.

Referring to FIG. 1, fuel inlet 30 is connected to a first fuel flow line 34 that originates from gasoline fuel tank 14. Fuel outlet 32 is connected to a second fuel flow line 36 that extends to internal combustion engine 12.

Referring to FIG. 2, sealed fittings 33 are used to seal the connections between fuel inlet 30 and first fuel flow line 34 and fuel outlet 32 and second fuel flow line 36 to prevent any leakage of fuel.

Referring to FIG. 1, fuel from gasoline fuel tank 14 flows along first fuel flow line 34 through fuel inlet 30 into fuel circulation conduit 28. After circulating through fuel circulation conduit 28, fuel exits through fuel outlet 32 and passes along second fuel flow line 36. Second fuel flow line 36 feeds fuel into internal combustion engine 12 for consumption by internal combustion engine 12.

Referring to FIG. 2, a heated fluid inlet 38 is located at first end 24 of cylindrical body 22 of heat exchanger 20 and a heated fluid outlet 40 is located at second end 26 of cylindrical body 22 of heat exchanger 20 such that heat exchanger 20 is heated by the circulation of heated fluid through heated fluid inlet 38 to heated fluid outlet 40. Fuel is contained separately from heated fluid within fuel circulation conduit 28.

Referring to FIG. 1, heated fluid inlet 38 is connected to a first engine coolant flow line 42 that originates from internal combustion engine 12. Heated fluid from internal combustion engine 12 flows along first engine coolant flow line 42 and passes through an engine coolant pump 44 which pumps heated fluid (in this case coolant) through heated fluid inlet 38 into heat exchanger 20. Heated fluid outlet 40 is connected to a second engine coolant flow line 46 that extends to radiator 16 so that after cooling by passing through heat exchanger 20 and radiator 16, heated fluid circulates from heat exchanger 20 back into internal combustion engine 12. It will be appreciated that although coolant has been used as the heated fluid for purposes of illustration, oil, exhaust or other fluids may also be used.

Referring to FIG. 1, a temperature sensor 48 is positioned in second fuel flow line 36. Temperature sensor 48 is connected to a first vacuum line 50 that extends to engine manifold vacuum 18. A control unit 52 is coupled to temperature sensor 48. A vacuum actuated valve 54 is positioned on first engine coolant flow line 42 before heated fluid inlet 38. Control unit 52 operates vacuum actuated valve 54 to control the temperature of heat exchanger 20 by regulating the flow of heated coolant through heat exchanger 20 so as to maintain gasoline fuel within a predetermined temperature range of not less than 40 degrees celsius and not more than 58 degrees celsius as sensed by temperature sensor 48. A second vacuum line 56 extends from temperature sensor 48 to vacuum actuated valve 54 and passes along vacuum force originating from engine manifold vacuum 18 for vacuum actuated valve 54 to operate.

In a situation where the vehicle is powered by a diesel engine, the engine manifold vacuum 18 will be replaced by a 12V DC power supply and first vacuum line 50 and second vacuum line 56 will be replaced by a first power line and a second power line. Vacuum actuated valve 54 will be replaced by an electric solenoid water valve which will be operated by power from 12V DC power supply supplied through first and second power lines. Where the fuel being used is diesel, the predetermined temperature range to which the fuel is heated is not less than 45 degrees celsius and not more than 74 degrees celsius.

Combination apparatus 10 is used in accordance with the teachings of a preferred method. This method includes the following steps. A first step involves installing a heat exchanger 20 in a vehicle powered by internal combustion engine 12, substantially as described above. A second step involves placing a temperature sensor 48 in second fuel flow line 36 and monitoring a temperature of fuel passing through second fuel flow line 36. A third step involves adjusting the rate and volume of flow through heat exchanger 20 to maintain fuel within a predetermined temperature range. The predetermined temperature range depends upon the type of fuel. When the vehicle operates in an environment with extremes of temperature, temperature sensor 48 must remain a permanent part of the system so that adjustments may be made, as required, through a controller, such as control unit 52 illustrated and described above. When the vehicle operates in an environment with relatively constant temperatures, once heat exchanger 20 is set up to operate within the temperature range required by the fuel, temperature sensor 48 and control unit 52 can be removed. The fuel flow rate and volume of a vehicle having a large engine will, of course, be greater than that of a vehicle having a small engine. A cold weather operating environment in the arctic will, of course, have different demands than a warm weather operating environment in Arizona. Whether operating in a cold environment or a hot environment, the relatively constant outdoor temperatures enable heat exchanger 20 to be permanently configured to suit the temperature requirements of the fuel. By definition, a permanent configuration will have a constant rate and volume of flow through heat exchanger 20. The configuration must, therefore, be accomplished by adjusting the length of the flow lines. The flow lines that are of particular relevance are first engine coolant flow line 42 that feeds heated fluid into heated fluid inlet 38 of heat exchanger 20, fuel circulation conduit 28 that carries fuel through heat exchanger 20 and second fuel flow line 36 that carries preheated fuel from heat exchanger 20 to engine 12.

It will be apparent to one skilled in the art that modifications may be made to the illustrated embodiment without departing from the spirit and scope of the invention as hereinafter defined in the Claims.

The embodiments of the invention in which an exclusive property or privilege is claimed are defined as follows:

1. An apparatus for preheating fuel in vehicles powered by internal combustion engines, comprising in combination:
a vehicle powered by an internal combustion engine supplied with fuel from a fuel tank;
a heat exchanger for indirect heating of fuel, the heat exchanger having a fuel circulation conduit with a fuel inlet and a fuel outlet, the fuel inlet being connected to a first fuel flow line originating from the fuel tank, the fuel outlet being connected to a second fuel flow line extending to the internal combustion engine;
a temperature sensor in the second fuel flow line;
a control unit coupled to the temperature sensor for controlling the temperature of the heat exchanger to maintain fuel within a predetermined temperature range as sensed by the temperature sensor.

2. The apparatus as defined in claim 1, wherein the heat exchanger has a heated fluid inlet and a heated fluid outlet, the heat exchanger being heated by the circulation of heated fluid through the heated fluid inlet to the heated fluid outlet.

3. The apparatus as defined in claim 2, wherein the heated fluid is one of coolant, oil, and exhaust gas.

4. The apparatus as defined in claim 1, wherein the fuel is gasoline and the predetermined temperature range to which the fuel is heated is not less than 40 degrees celsius and not more than 58 degrees celsius.

5. The apparatus as defined in claim 1, wherein the fuel is diesel and the predetermined temperature range to which the fuel is heated is not less than 45 degrees celsius and not more than 74 degrees celsius.

6. The apparatus as defined in claim 2, wherein a first heated fluid flow line is connected to the heated fluid inlet and a second heated fluid flow line is connected to the heated fluid outlet, a controller operating a valve positioned on one of the first heated fluid flow line and the heated fluid inlet to control flow of heated fluid through the heat exchanger.

7. An apparatus for preheating fuel in vehicles powered by internal combustion engines, comprising in combination:
a vehicle powered by an internal combustion engine supplied with gasoline fuel from a gasoline fuel tank, the vehicle having a radiator;
a heat exchanger for indirect heating of fuel, the heat exchanger having a fuel circulation conduit with a fuel inlet and a fuel outlet, the fuel inlet being connected to a first fuel flow line originating from the gasoline fuel tank, the fuel outlet being connected to a second fuel flow line extending to the internal combustion engine, the heat exchanger having a heated fluid inlet and a heated fluid outlet such that the heat exchanger is heated by the circulation of heated fluid through the heated fluid inlet to the heated fluid outlet, the heated fluid inlet being connected to a first heated fluid flow line originating from the internal combustion engine, the heated fluid outlet being connected to a second heated fluid flow line;
a temperature sensor in the second fuel flow line;
a control unit coupled to the temperature sensor and a valve positioned on one of the first heated fluid flow line and the heated fluid inlet, the control unit operating the valve to control the temperature of the heat exchanger by regulating the flow of heated fluid through the heat exchanger to maintain the gasoline fuel within a predetermined temperature range of not less than 40 degrees celsius and not more than 58 degrees celsius as sensed by the temperature sensor.

8. A method for preheating fuel in vehicles powered by internal combustion engines, comprising the following steps:
firstly, installing a heat exchanger in a vehicle powered by an internal combustion engine supplied with fuel from a fuel tank, the heat exchanger having a fuel circulation conduit with a fuel inlet and a fuel outlet, the fuel inlet of the heat exchanger being connected to a first fuel flow line originating from the fuel tank, the fuel outlet of the heat exchanger being connected to a second fuel flow line extending to the internal combustion engine;
secondly, placing a temperature sensor on the second fuel flow line and monitoring a temperature of fuel passing through the second fuel flow line; and
thirdly, making adjustments to maintain fuel passing along the second fuel flow line within a predetermined temperature range.

9. The method as defined in claim 8, wherein the fuel is gasoline and the predetermined temperature range to which the fuel is heated is not less than 40 degrees celsius and not more than 58 degrees celsius.

10. The method as defined in claim 8, wherein the fuel is diesel and the predetermined temperature range to which the fuel is heated is not less than 45 degrees celsius and not more than 74 degrees celsius.

11. The method as defined in claim 8, wherein a first heated fluid flow line is connected to the heated fluid inlet and a second heated fluid flow line is connected to the heated fluid outlet, a controller operating a valve positioned on one of the first heated fluid flow line and the heated fluid inlet to control flow of heated fluid through the heat exchanger to maintain fuel passing along the second fuel flow line within the predetermined temperature range.

12. The method as defined in claim 8, the heat exchanger having a heated fluid inlet and a heated fluid outlet, a heated fluid flow line feeding heated fluid into the heated fluid inlet of the heat exchanger, adjustments being made to the length of at least one of the first heated fluid flow line, the fuel circulation conduit and the second fuel flow line to maintain the temperature of fuel passing through the second fuel flow line within the predetermined temperature range.
